(19) United States
(12) Patent Application Publication
(10) Pub. No.: US 2009/0066109 A1
(43) Pub. Date: Mar. 12, 2009

(54) SUN VISOR VANITY ASSEMBLY

(76) Inventors: James J. Hobson, Hanover, MI (US); Derik Reichhart, Coldwater, MI (US)

Correspondence Address: DICKINSON WRIGHT PLLC, Suite 2000, 38525 Woodward Avenue, Bloomfield Hills, MI, 48304-5092, US

(21) Appl. No.: 11/853,828

(22) Filed: Sep. 12, 2007

(51) Int. Cl. B60J 3/02; B60Q 3/02

(52) U.S. Cl. 296/97.9; 362/492

(57) ABSTRACT

A sun visor vanity assembly is provided including a visor element and a clamshell element positioned within. A power wire harness is mounted on the clamshell element as well as a vanity frame. A conductive hinge element is mounted between the vanity frame and the external surface and includes a spring body, at least one direct connect arm electrically engaging the power harness, and a flexible spring door arm. A vanity door includes a hinge engagement element rotatably engaging the flexible spring door arm and is movable between a door open position and a door closed position. A vanity light element is mounted into the vanity door body and is in electrical communication with the flexible spring door arm when in the door open position.

### TECHNICAL FIELD

The present invention relates generally to a sun visor vanity assembly and more particularly to a sun visor vanity assembly with a conductive hinge element.

### BACKGROUND OF THE INVENTION

Automotive environments provide an extensive array of challenges towards engineering design. These challenges increasingly involve the routing of power and electrical communications to numerous positions within the vehicle. Electrical wiring often increasing the complexity of manufacturing and can interfere with automated processes. In addition, increased wiring can have a substantial negative impact on vehicle production costs.

On such assembly involved is the common sun visor. It is well known that sun visor assemblies often incorporate mirrors and lighting such that a consumer can utilize them in low light situations. Often the visor lighting is adjacent the mirror in the main visor body. While this simplifies the wiring requirements it does not provide optimal lighting for the passenger. Non-direct or angled lighting can produce more desirable effect than direct lighting. As such, it would be highly desirable to move the visor lighting off the main body surface of the visor. One approach would be to move the lighting to the vanity door. While this may be accomplished through the use of flexible circuits, this approach would increase the complexity and cost of assembly in addition to providing difficulties to automation.

Therefore it would be highly desirable to have a sun visor vanity assembly that could incorporate lighting into the visor door. It would also be highly desirable for such a sun visor vanity assembly to accomplish this without the need for complex wiring assemblies that increase cost and interfere with automated assembly.

### SUMMARY OF THE INVENTION

In accordance with the desires of the present invention a sun visor vanity assembly is provided including a visor element and a clamshell element positioned within. A power wire harness is mounted on the clamshell element as well as a vanity frame. A conductive hinge element is mounted between the vanity frame and the external surface and includes a spring body, at least one direct connect arm electrically engaging the power harness, and a flexible spring door arm. A vanity door includes a hinge engagement element rotatably engaging the flexible spring door arm and is movable between a door open position and a door closed position. A vanity light element is mounted into the vanity door body and is in electrical communication with the flexible spring door arm when in the door open position.

Other objects and features of the present invention will become apparent when viewed in light of the detailed description and preferred embodiment when taken in conjunction with the attached drawings and claims.

### BRIEF DESCRIPTION OF THE DRAWINGS

FIG. 1 is an illustration of a sun visor vanity assembly in accordance with the present invention.

FIG. 2 is an exploded view illustration of the sun visor vanity assembly illustrated in FIG. 1.

FIG. 3 is a cross-sectional illustration of the sun visor vanity assembly illustrated in FIG. 1 the illustration depicting installation into a device.

FIG. 4 is a detailed illustration of the sun visor vanity assembly illustrated in FIG. 1.

### DESCRIPTION OF PREFERRED EMBODIMENTS

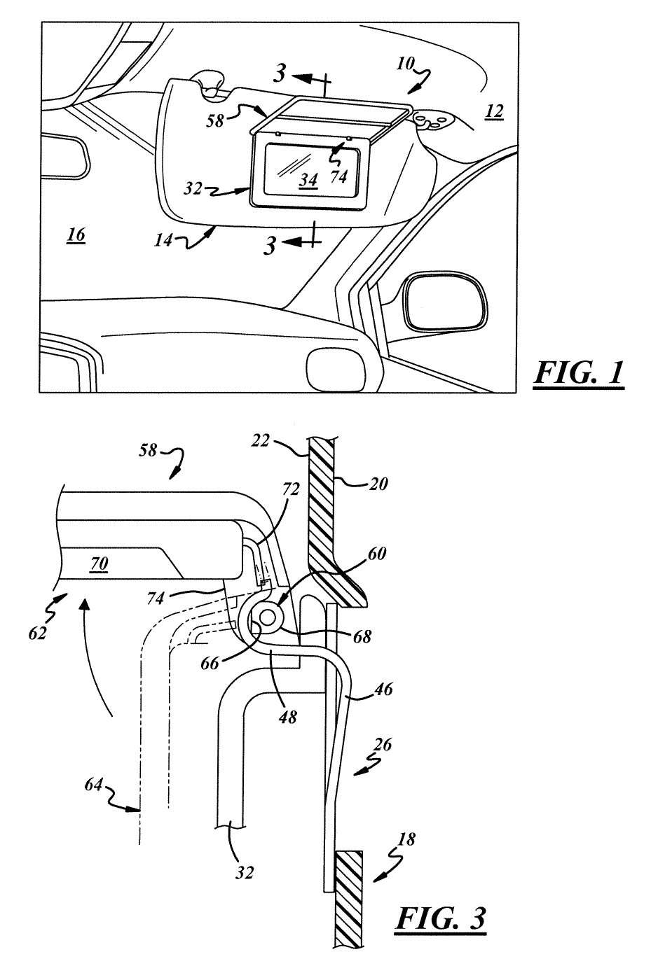

Referring now to FIG. 1, which is an illustration of a sun visor vanity assembly 10 in accordance with the present invention. The sun visor vanity assembly 10 is illustrated mounted within a vehicle interior 12 in accordance with common sun visor usage. It should be understood, however, that a variety of locations and mounting configurations are contemplated and would apparent in light of the contents of this disclosure. The sun visor vanity assembly 10 includes a visor element 14 rotatably mounted to the vehicle interior 12. As is with common usage, the visor element 14 is rotated downwards to partially the direct impact of sunlight entering through the vehicle windshield 16.

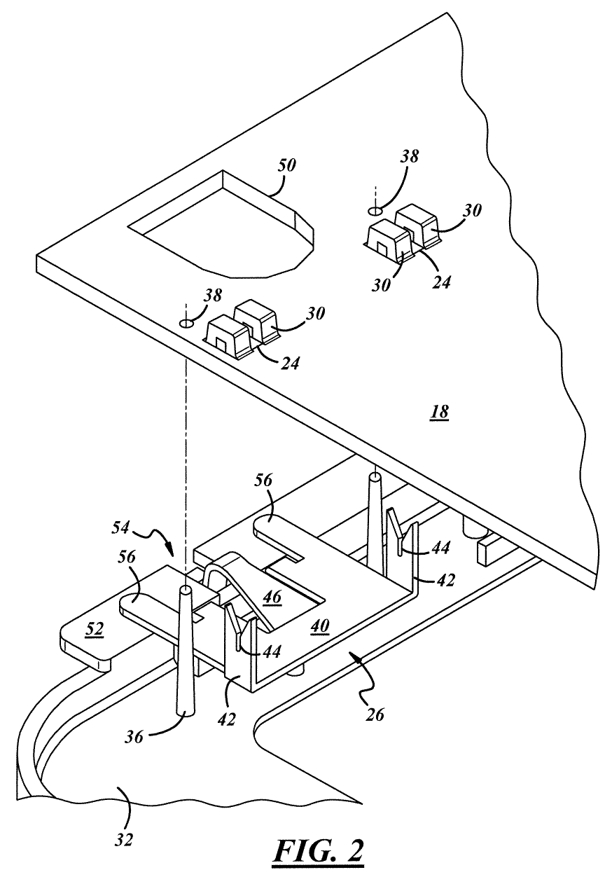

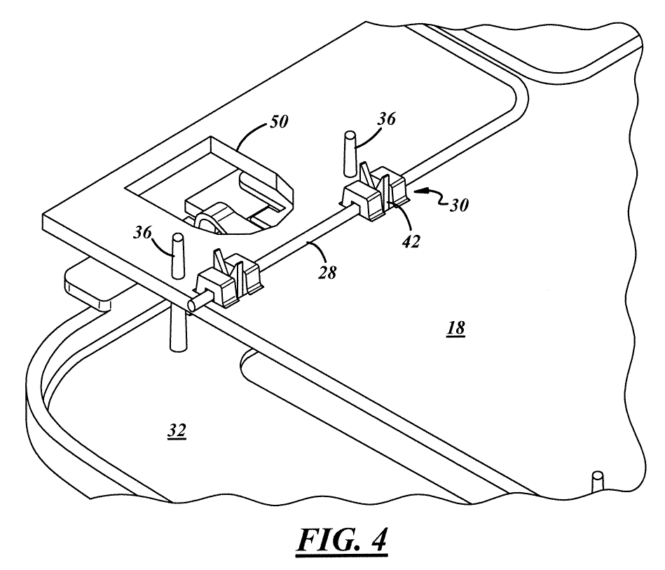

The present invention provides a simplified and improved construction for the sun visor vanity assembly 10. The sun visor vanity assembly 10 includes a clamshell element 18 mounted within the visor element 14 (see FIGS. 2 and 3). The clamshell element 18 is a rigid element mounted within the soft covering of the visor element 14. The clamshell element 18 is comprised of an interior surface 20 and an exterior surface 22. The clamshell element 18 further includes at least one arm receptacle 24 formed therein to provide access between the exterior and interior surfaces 22, 20. Although a variety of arm receptacles 24 are contemplated, one embodiment contemplates a pair of arm receptacles 24 corresponding to each conductive hinge element 26 utilized.

A power wire harness 28 is mounted on the interior surface 20 and transports electrical power. The power wire harness 28 preferably is positioned to pass directly over the arm receptacles 24. In at least one embodiment, insulator displacement elements 30 such as tunnel elements are positioned immediately adjacent the arm receptacles 24. These insulator displacements elements 30 are utilized to push any interior structure of the vanity element 14 out of the way upon installation so as no to interfere with either the power wire harness 28 or the arm receptacles 24. When utilizing tunnel elements 30 the power wire harness 28 may be passed through the tunnel elements 30 and thereby be secured in position. In at least one embodiment, it is contemplated that a pair of tunnel elements 30 be positioned on either side of each arm receptacle 24.

A vanity frame 32 is mounted to the exterior surface 22 and is preferably a molded rigid plastic frame including a mirror element 34. Although the vanity frame 32 may be mounted to the clamshell element 18 in a variety of fashions, one embodiment contemplates the use of a plurality of mount posts 36 formed on the vanity frame 32 engaging a plurality of mount holes 38 formed in the clamshell element 18. This allows a press-fit lock engagement suitable for easy installation. The present invention contemplates the use of a conductive hinge element 26 to be mounted between the vanity frame 32 and the clamshell element 18. The conductive hinge element 26 is electrically conductive. The conductive hinge element 26 includes a spring body 40. At least one direct connect arm 42 extends upward at a ninety degree angle from the spring body 40. The direct connect arm 42 is configured to mount upwards through the arm receptacle 24 and directly electrically engage the power wire harness 28. In the embodiment illustrated a pair of direct connect arms 42 are utilized for each hinge 26 and positioned on both sides of the spring body 40. Although a variety of engagement methodologies may be utilized, a v-groove engagement slot 44 may be formed in the direct connect arms 42 to engage the power wire harness 28. The v-groove engagement slot 44 may be configured to pierce any shielding on the power wire harness 28 or alternatively the shielding may be stripped prior to hinge installation.

The conductive hinge element further includes a flexible spring door arm 46 extending from the spring body 40. The flexible spring door arm 46 preferably extends upwards towards said internal surface 20 and then curves outwards at a curved door engagement surface 48. The curved door engagement surface 48 protrudes past the vanity frame 32. A spring movement clearance abscess 50 may be formed in the clamshell element 18 to allow free movement of the flexible spring door arm 46. Although the curved door engagement surface 48 may protrude past the vanity frame 32 in a variety of fashions, in one embodiment the vanity frame 32 includes a lip element 52 containing a lip gap 54. The flexible spring door arm 46 is mounted such that the curved door engagement surface 48 protrudes through the lip gap 54. A pair of spring mount arms 56 extending from the spring body 40 are configured to engage the lip element 52 to secure the spring body 40 and provide the spring functioning to the flexible spring door arm 46.

The invention further includes a vanity door 58 including a hinge engagement element 60 configured to rotatably engage the curved door engagement surface 48. The vanity door 58 is thereby rotatable between a door open position 62 and a door closed position 64. The hinge engagement element 60 is preferably cylindrical with a flat portion 66. This allows the flexible spring door arm 46, which is biased pulling towards the internal surface 20, to effectively bias the vanity door 58 towards the door closed position 64. The flat portion 66 restrains the vanity door 58 in the door open position 62 until a user moves the vanity door 58 until the cylindrical portion 68 contacts the curved door engagement surface 48. The vanity door 58 includes a vanity light element 70 mounted within. The vanity light element 70 is configured to be in electrical communication with the conductive hinge element 26 at least in the door open position 62. Thus the conductive hinge element 26 communicates electrical power from the power wire harness 28 to the vanity light element 70. In one embodiment, the a switch element 72 is mounted in communication with the vanity light element 70 and only contacts the conductive hinge element 26 when in the door open position 62. Finally, the vanity door 58 may include a hinge cover 74 preventing exposure of the curved door engagement surface 48 when in the door open position 62.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A sun visor vanity assembly comprising:
a visor element;
a clamshell element positioned within said visor element, said clamshell element having an internal surface, an external surface, and at least one arm receptacle;
a power wire harness mounted on said internal surface and positioned over said at least one arm receptacle;
a vanity frame mounted to said external surface;
a conductive hinge element mounted between said vanity frame and said external surface, said conductive hinge element comprising:
a spring body;
at least one direct connect arm protruding from said spring body and directly electrically engaging said power harness; and
a flexible spring door arm extending from said spring body and including a curved door engagement surface protruding past said vanity frame;
a vanity door comprising:
a vanity door body including a hinge engagement element rotatably engaging said curved door engagement surface, said vanity door body movable between a door open position and a door closed position, said flexible spring door arm biasing said vanity door body into said door closed position;
a vanity light element mounted into said vanity door body, said vanity light element in electrical communication with said flexible spring door arm when in said door open position.

2. A sun visor vanity assembly as described in claim 1, further comprising:
a switch element in electrical communication with said vanity door element, said switch element only engaging said flexible spring door arm when in said door open position.

3. A sun visor vanity assembly as described in claim 1, wherein said vanity frame includes:
a lip element; and
a lip gap formed in said lip element, said curved door engagement surface protruding through said lip gap.

4. A sun visor vanity assembly as described in claim 1, wherein said at least one direct connect arm comprises:
a v-groove engagement slot configured to engage said power wire harness.

5. A sun visor vanity assembly as described in claim 1, further comprising:
a spring movement clearance abscess formed in said clamshell element.

6. A sun visor vanity assembly as described in claim 1, further comprising:
at least one insulator displacement element protruding from said internal surface adjacent said at least one arm receptacle.

7. A sun visor vanity assembly as described in claim 6, wherein said at least one insulation displacement element comprises a tunnel element, said power wire harness passing through said tunnel element.

8. A sun visor vanity assembly as described in claim 1, further comprising:
a plurality of mount holes formed in said clamshell element; and
a plurality of mounting posts formed in said vanity frame, said mounting posts engaging said mount holes to secure said vanity frame to said clamshell element.

9. A sun visor vanity assembly as described in claim 3, wherein said conductive hinge element further comprises:
a pair of spring mount arms positioned on opposing sides of said flexible spring door arm and engaging said lip element.

10. A sun visor vanity assembly comprising:
a visor element;
a clamshell element positioned within said visor element, said clamshell element having an internal surface and an external surface;
a power wire harness mounted on said clamshell element;
a vanity frame mounted to said external surface;
a conductive hinge element mounted between said vanity frame and said external surface, said conductive hinge element comprising:
a spring body;
at least one direct connect arm electrically engaging said power harness; and
a flexible spring door arm extending from said spring body;
a vanity door comprising:
a vanity door body including a hinge engagement element rotatably engaging said flexible spring door arm, said vanity door body movable between a door open position and a door closed position;
a vanity light element mounted into said vanity door body, said vanity light element in electrical communication with said flexible spring door arm when in said door open position.

11. A sun visor vanity assembly as described in claim 10, further comprising:
a switch element in electrical communication with said vanity door element, said switch element only engaging said flexible spring door arm when in said door open position.

12. A sun visor vanity assembly as described in claim 10, wherein said vanity frame includes:
a lip element; and
a lip gap formed in said lip element, said flexible spring door arm protruding through said lip gap.

13. A sun visor vanity assembly as described in claim 10, wherein said at least one direct connect arm comprises:
a v-groove engagement slot configured to engage said power wire harness.

14. A sun visor vanity assembly as described in claim 10, further comprising:
a spring movement clearance abscess formed in said clamshell element.

15. A sun visor vanity assembly as described in claim 10, further comprising:
a plurality of mount holes formed in said clamshell element; and
a plurality of mounting posts formed in said vanity frame, said mounting posts engaging said mount holes to secure said vanity frame to said clamshell element.

16. A sun visor vanity assembly as described in claim 12, wherein said conductive hinge element further comprises:
a pair of spring mount arms positioned on opposing sides of said flexible spring door arm and engaging said lip element.

17. A method of manufacturing a sun visor vanity assembly comprising:
mounting a power wire harness to a clamshell element;
mounting said clamshell element with in a visor element;
mounting a conductive hinge element against said clamshell element, said conductive hinge element comprising a direct connect arm in electrical communication with said power wire harness and a flexible spring door arm;
mounting a vanity frame onto said clamshell element such that said conductive hinge element is positioned between said vanity frame and said clamshell element;
rotatably mounting a vanity door onto said vanity frame by way of a hinge engagement element rotatably engaging said flexible spring door arm, said vanity door including a vanity light element in electrical communication with said flexible spring door arm, aid conductive hinge element placing said vanity light element in electrical communication with said power wire harness

18. A method as described in claim 17, wherein said mounting said conductive hinge element against said clamshell element comprises:
inserting said direct connect arm through an arm receptacle formed in said clamshell element.

19. A method as described in claim 17, further comprising:
mounting a switch element in said vanity door such that said vanity light element is in communication with said flexible spring door arm only when in a door open position.

20. A method as described in claim 18, wherein said flexible spring door arm comprises a curved door engagement surface protruding past said vanity frame, said curved door engagement surface rotatably engaging said hinge engagement element.
